(19) United States
(12) Patent Application Publication
(10) Pub. No.: US 2004/0183936 A1
(43) Pub. Date: Sep. 23, 2004

(54) Digital camera module, apparatus and method of assembling the same

(76) Inventors: Young-Jun Kim, Seongnam-si (KR); Choong-Gunn Park, Seoul (KR)

Correspondence Address: GOTTLIEB RACKMAN & REISMAN PC, 270 MADISON AVENUE, 8TH FLOOR, NEW YORK, NY, 100160601

(21) Appl. No.: 10/643,694

(22) Filed: Aug. 18, 2003

(30) Foreign Application Priority Data
Mar. 18, 2003 (KR) 2003-16869

(51) Int. Cl. H04N 5/225

(52) U.S. Cl. 348/340

(57) ABSTRACT

A digital camera module, an apparatus and method of assembling the digital camera module are disclosed. The digital camera module includes a barrel having external threads on an external surface thereof, with one or more lenses set in the barrel, and an assembling plate mounted to an upper surface of the barrel. A camera module housing is assembled with the barrel, and has an internally threaded opening through which the barrel is mounted to the housing. The digital camera module also has an image sensor converting an image of a subject into an electrical image signal, and a substrate having an electronic circuit, with the image sensor installed on the substrate. The method of assembling the digital camera module comprise holding a plurality of barrels, each having a magnetic assembling plate, in a jig having a first magnet; assembling one or more lenses in each of the barrels held in the jig so as to align the lenses in the barrel; attaching each of the barrels having the lenses to an assembling handler having a second magnet; and assembling each of the barrels to a camera module housing by manipulating the assembling handler. The apparatus for assembling a digital camera module is comprised of the jig and the assembling handler.

### BACKGROUND OF THE INVENTION

1. Field of the Invention

The present invention relates, in general, to digital camera modules having image sensors to store and transmit digital images and, more particularly, to a digital camera module comprised of a lens assembly and an image sensor, and to an apparatus and method of assembling a barrel, used as a lens holder of the lens assembly, with a camera module housing.

2. Description of the Prior Art

As well known to those skilled in the art, digital camera modules used in a variety of products, such as PC cameras, digital cameras, mobile phones, PDAs, etc., are fabricated with an image sensor and a lens assembly. In such a digital camera module, the image sensor is the primary element to store and transmit digital images, and feed image data back, in real time. In accordance with the recent trend of complexity, multiple functions, smallness, compactness and lightness of the PC cameras, digital cameras, mobile phones, PDAs, etc., the digital camera modules are required to be produced as small, compact and light modules.

In addition, in accordance with practical use of high-resolution image sensors, such as CCD and CMOS, in digital camera modules, it is required to accomplish miniaturization and superprecision of lenses, and this results in the production of miniaturized lens assemblies for digital camera modules.

In accordance with the recent trend of miniaturization of the lens assemblies for digital camera modules, work efficiency while assembling lenses in a barrel of a lens assembly, positional precision of the lenses in the barrel, and prevention of undesired removal of the lenses from the barrel, are recognized as primary factors determining productivity during a process of producing lens assemblies.

As shown in FIG. 1, the conventional digital camera module comprises a lens assembly. The lens assembly of the digital camera module is comprised of two parts, that is, a barrel 1, used as a lens holder for holding one or more lenses (not shown) in the lens assembly, and a camera module housing 2 assembled with the barrel 1 to hold the barrel 1.

The lenses of the lens assembly include a plurality of convex and concave lenses, and are sequentially set in the barrel 1 while being precisely controlled in positions thereof and intervals therebetween.

The barrel 1 is a cylindrical body having external threads 1a on its surface, while the housing 2 has an opening 2a with internal threads which engage with the external threads of the barrel 1.

A substrate 3 of the digital camera module is printed with an electronic circuit, and is mounted to the lower surface of the housing 2, with a high resolution image sensor (not shown) installed on an upper surface of the substrate 3. The image sensor converts an image of a subject into an electrical image signal so as to accomplish digital image storage and transmission of the digital camera module.

Typically, CMOS is typically used as the image sensor.

The barrel 1 is typically made of aluminum or synthetic resin material.

FIG. 2 is a perspective view of a capped barrel of the lens assembly included in the digital camera module of FIG. 1. As shown in the drawing, the capped barrel 1 comprises a cylindrical body having external threads 1a on its external surface, with a cap 1b mounted to the externally threaded cylindrical body.

In order to produce a lens assembly using the capped barrel 1, a worker on an assembling line primarily sets one or more lenses in the barrel 1 while holding the cap 1b of the barrel 1. The barrel 1 having the lenses is, thereafter, assembled with the housing 2 by engaging the external threads 1a of the barrel 1 with the internal threads of the housing's opening 2a.

However, the conventional capped barrel 1 has a large size due to the cap 1b, so that the barrel 1 is not suitable for accomplishing the recent trend of smallness, compactness and lightness of digital camera modules. Therefore, the demand for such large-sized capped barrels 1 is diminishing.

FIG. 3 is a perspective view of a capless barrel, used in a lens assembly of a digital camera module, according to another embodiment of the prior art. As shown in the drawing, the capless barrel 5 of this embodiment does not have any cap, but is externally threaded on the whole area of its external surface, so that external threads 5a are formed on the whole area of the external surface.

In order to produce a lens assembly using the capless barrel 5, a worker on an assembling line primarily sets lenses in the barrel 5 while holding the externally threaded surface of the barrel 5. The barrel 5 having the lenses is, thereafter, assembled with the housing 2 by engaging the external threads 5a of the barrel 5 with the internal threads of the housing's opening 2a.

Since the capless barrel 5 does not have any cap, it can be preferably reduced in its size, so that the demand for such barrels 5 is gradually increasing.

However, the capless barrel 5 is problematic in that it is very difficult to hold the barrel 5 without tilting the barrel 5 due to the external threads 5a, during a process of setting the lenses in the barrel 5, so that the lenses may be misaligned or misassembled in the barrel 5.

That is, in order to produce the lens assembly using the capless barrel 5, the worker on the assembling line must insert the lenses sequentially in the barrel 5 while holding the threaded external surface of the barrel 1, prior to fixing the lenses in the barrel 5. During the process of producing the lens assembly, the barrel 5 may be held at a tilted position due to the external threads 5a, and, in such a case, it is almost impossible to assemble the lenses in the barrel 5 at desired precise positions.

In other words, the external threads 5a of the capless barrel 5 often cause errors in the assembling of the lenses in the barrel 5.

In accordance with the diversification of products using the digital cameral modules and a remarkable increase in the demand for such products in recent years, it is necessary to produce the digital camera modules in great quantities. The necessity for producing the digital camera modules in great quantities forces the manufacturers of digital camera modules to produce the lens assemblies, each comprising a barrel as the lens holder and a housing assembled with the barrel, in large quantities.

However, the small-sized capless barrel 5, which has the external threads 5a on the whole area of the external surface of its cylindrical body, is difficult to hold due to the external threads 5a, during a process of setting the lenses in the barrel 5, as described above, so that it is almost impossible to produce the lens assemblies using the capless barrels 5 in large quantities.

In addition, during a process of mounting the capless barrel 5 having the lenses to the housing 2, it is necessary to precisely mount the barrel 5 to the housing 2 while carefully controlling the rotation angle of the barrel 5 relative to the housing 2 and repeatedly check the lens focusing precision. However, the capless barrel 5 and the housing 2 have very small sizes, so that it is not easy to handle the barrel 5 and the housing 2, during the process of rotating the barrel 5 relative to the housing 2.

Furthermore, in accordance with the recent trend of miniaturization of the lenses for digital camera modules, it is not easy even for skilled workers to accomplish desired lens focusing precision while manually assembling the barrel 5 with the housing 2. Therefore, mass production of digital camera modules encounters difficulty.

### SUMMARY OF THE INVENTION

Accordingly, the present invention has been made keeping in mind the above problems occurring in the prior art, and an object of the present invention is to provide a digital camera module, which is designed to improve work efficiency during a process of assembling lenses in a barrel to produce a miniaturized lens assembly accomplishing the recent trend of miniaturization of digital camera modules, and which is designed to allow a worker to set the lenses in the barrel while stably holding the barrel without tilting it, thus preventing any lens assembly errors.

It is another object of the present invention to provide a digital camera module, which is designed to allow a worker to easily hold the barrel having the lenses, thus improving work efficiency during a process of assembling the barrel with a camera module housing.

It is a further object of the present invention to provide a digital camera module, which is designed to accomplish the mass production of barrels, and allow workers to easily assemble the barrels with camera module housings, thus accomplishing the production of digital camera modules in great quantities.

It is still another object of the present invention to provide a digital camera module, which is designed to enhance and make uniform performance of products using the digital camera modules, and improve work efficiency while producing the products.

In order to accomplish the above objects, the present invention provides a digital camera module, comprising: a barrel having external threads on an external surface thereof, with one or more lenses set in the barrel, and an assembling plate mounted to an upper surface of the barrel; a camera module housing assembled with the barrel, the housing having an internally threaded opening through which the barrel is mounted to the housing; an image sensor converting an image of a subject into an electrical image signal; and a substrate having an electronic circuit, with the image sensor installed on the substrate.

In the digital camera module, the assembling plate is made of a magnetic material or a metal sheet which is magnetically attracted to a magnet.

The assembling plate is also provided with a baffle so as to prevent an incidence of undesired light beams to the lenses of the barrel.

The assembling plate is preferably provided with a plurality of tool holes so as to hold the barrel during a process of assembling the barrel with the housing.

In the present invention, it is preferred to mount the assembling plate to the upper surface of the barrel through a bonding technique by use of an adhesive.

In another aspect, the present invention provides a method of assembling a digital camera module, comprising: holding a plurality of barrels, each having a magnetic assembling plate, in a jig having a first magnet; assembling one or more lenses in each of the barrels held in the jig so as to align the lenses in the barrel; attaching each of the barrels having the lenses to an assembling handler having a second magnet; and assembling each of the barrels to a camera module housing by manipulating the assembling handler.

The assembling plate is made of a magnetic material or a metal sheet which is magnetically attracted to a magnet, and the barrel is held in the jig by magnetically attaching the assembling plate to the magnet of the jig.

The method of the present invention further comprises measuring a lens alignment after the lenses are assembled in each of the barrels.

In a further aspect, the present invention provides an apparatus for assembling a digital camera module, comprising: a jig having a first magnet to hold a plurality of barrels each having a magnetic assembling plate at an end thereof; and an assembling handler having a second magnet at an end thereof to be magnetically attached to the magnetic assembling plate of each of the barrels, the assembling handler being manipulated to assemble the barrel with a camera module housing.

In the apparatus, the jig has a plurality of barrel holding holes arranged in a line so as to hold the barrels such that a part of each of the barrels is seated in each of the barrel holding holes, with the first magnet placed at bottom surfaces of the barrel holding holes.

In the above apparatus, the assembling plate of each of the barrels is provided with a tool hole, and the second magnet of the assembling handler has an engaging projection to be inserted into the tool hole of the assembling plate.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view of a conventional digital camera module;

FIG. 2 is a perspective view of a capped barrel included in a lens assembly of the digital camera module of FIG. 1;

FIG. 3 is a perspective view of a capless barrel, used in a lens assembly of a digital camera module, according to another embodiment of the prior art;

FIG. 4 is an exploded perspective view of a digital camera module, according to a first embodiment of the present invention;

FIG. 5 is a perspective view of a barrel included in a lens assembly of the digital camera module of FIG. 4;

FIG. 6A is a sectional view of an assembling plate mounted to the barrel of FIG. 5;

FIGS. 6B and 6C are sectional views of assembling plates, according to first and second modifications of the first embodiment of the present invention;

FIG. 7 is a perspective view of a barrel, according to a second embodiment of the present invention;

FIG. 8 is a perspective view of a barrel, according to a third embodiment of the present invention;

FIG. 9 is a jig used in assembling of lenses in a barrel of the present invention; and

FIG. 10 is an exploded perspective view showing a method of assembling the barrel of FIG. 5 with a camera module housing of the digital camera module of FIG. 4 by use of an assembling handler, according to the present invention.

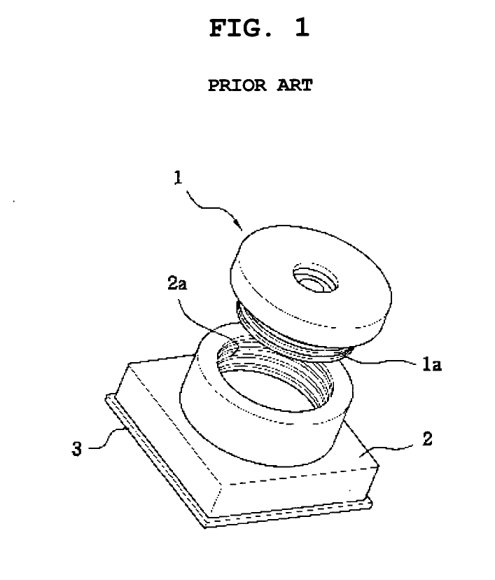

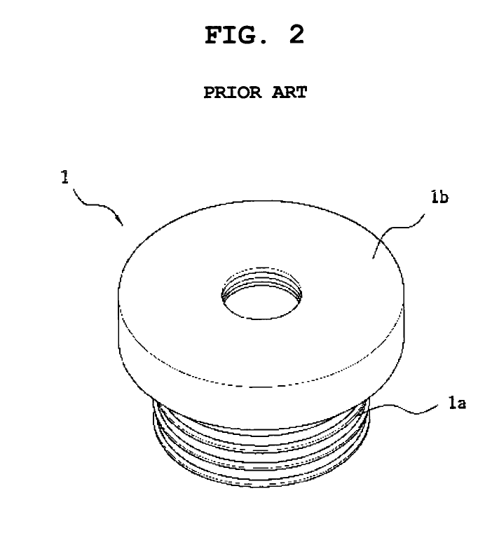

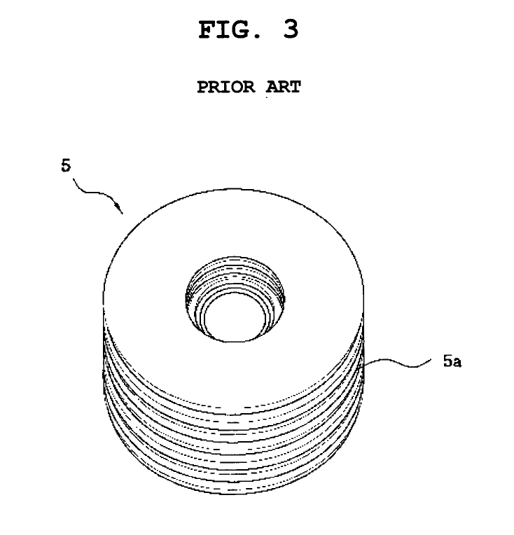

### DETAILED DESCRIPTION OF THE INVENTION

Reference should now be made to the drawings, in which the same reference numerals are used throughout the different drawings to designate the same or similar components.

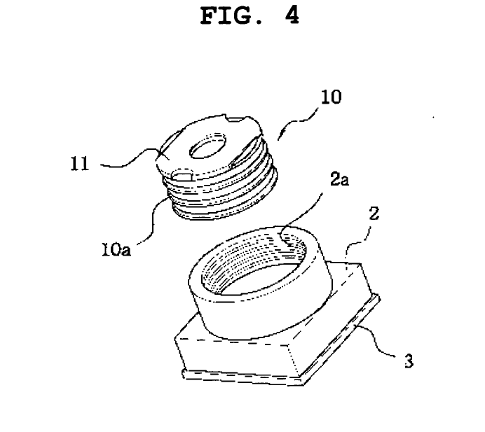

FIG. 4 is an exploded perspective view of a digital camera module, according to a first embodiment of the present invention. As shown in the drawing, the digital camera module according to the present invention comprises a lens assembly, and the lens assembly includes two parts, that is, a barrel 10, used as a lens holder for holding one or more lenses in the lens assembly, and a camera module housing 2 assembled with the barrel 10 to hold the barrel 10.

The barrel 10 is a cylindrical body having external threads 10a on its external surface.

The camera module housing 2 has an opening 2a through which the barrel 10 is inserted into the housing 2, and which has internal threads engaging with the external threads 10a of the barrel 10.

The digital camera module also comprises a substrate 3 printed with an electronic circuit. The substrate 3 is mounted to the lower surface of the housing 2, with an image sensor (not shown) installed on the substrate 3. The image sensor converts an image of a subject into an electrical image signal so as to accomplish digital image storage and transmission of the digital camera module.

In the digital camera module of the present invention, an assembling plate 11 is mounted to an upper surface of the barrel 10.

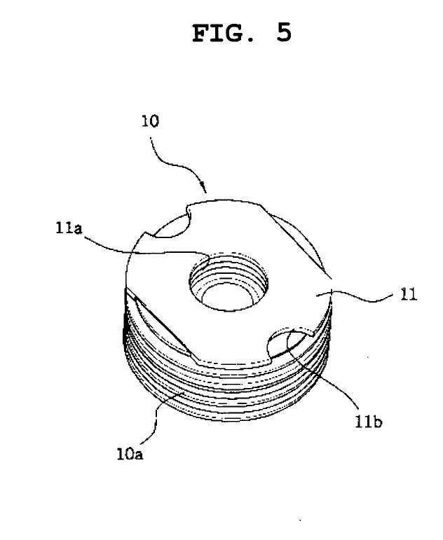

FIG. 5 is a perspective view of the barrel 10 included in the lens assembly of the digital camera module of FIG. 4. In the present invention, the assembling plate 11 is a thin plate member having a size and shape capable of covering most of the upper surface of the barrel 10.

In the first embodiment of the present invention, the thin assembling plate 11 has a profile that is obtained from linearly and symmetrically cutting opposite sides of a circular disc to form linear edges at the sides.

The assembling plate 11 is preferably made of a magnetic material or a metal sheet which is magnetically attracted to a magnet.

In the present invention, the assembling plate 11 is attached to the upper surface of the barrel 10 through a bonding technique by use of an adhesive during a process of assembling lenses with the barrel 10.

However, it should be understood that the technique of attaching the assembling plate 11 to the upper surface of the barrel 10 is not limited to the bonding technique using the adhesive, but may be accomplished by another technique.

A baffle 11a is formed at the assembling plate 11 so as to prevent an incidence of undesired light beams to the lenses of the barrel 10. In order to prevent the incidence of undesired light beams to the lenses of the barrel 10, the baffle 11a is shaped as a stepped hole which is formed at the center of the assembling plate 11 so as to effectively intercept diffused light beams.

As well known to those skilled in the art, baffles have been used for preventing the incidence of undesired light beams to the lenses of barrels in digital camera modules. In the prior art, the baffles are directly formed at the barrels of the lens assemblies of the digital camera modules. However, in accordance with the recent trend of compactness and miniaturization of the barrels, it is very difficult to directly form the baffles at the miniaturized barrels.

Different from the conventional digital camera modules, in the digital camera module of the present invention, the baffle is directly formed at the assembling plate through a pressing process wherein the assembling plate is produced by use of a mold having a part specified to form the baffle. Therefore, it is easy to form the baffle in the lens assembly even though a miniaturized barrel is used.

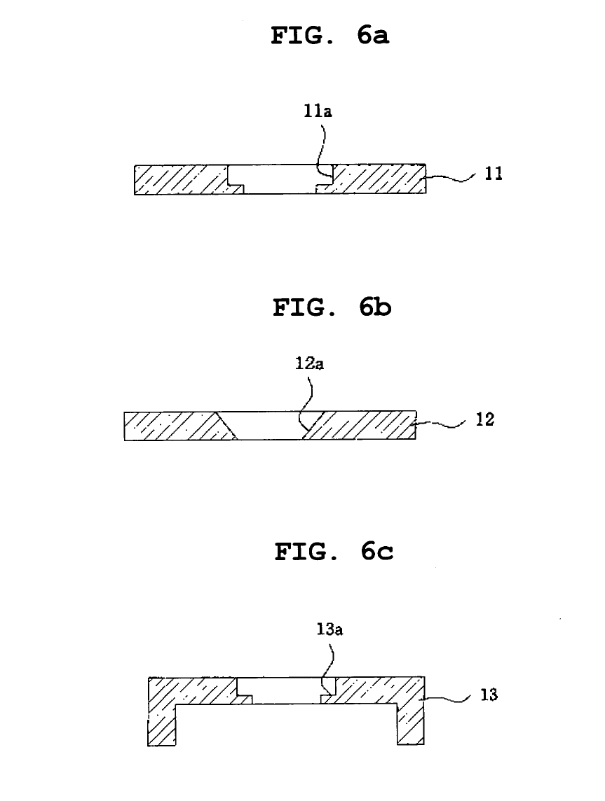

FIGS. 6A to 6C are sectional views of different assembling plates which can be used with the barrel 10 of FIG. 5, according to the first embodiment of the present invention. As shown in the drawings, it is possible to variously design the assembling plates and baffles for the barrel 10 to allow the plates and the baffles to have a variety of shapes.

In the assembling plate 11 of FIG. 6A, the baffle 11a is stepped once to have a large-diameter part at an upper portion, and a small-diameter part at a lower portion.

Since the assembling plate 11 of FIG. 6A has the stepped baffle 11a capable of effectively intercepting the diffused light beams, it is possible to prevent incidence of the undesired light beams to the lenses of the barrel 10.

FIGS. 6B and 6C are sectional views of assembling plates, according to first and second modifications of the first embodiment of the present invention. In the assembling plate 12 according to the first modification of FIG. 6B, the baffle 12a formed at the center of the assembling plate 12 is a tapered hole that is tapered downward.

The baffle 12a, shaped in the form of a tapered hole as described above, effectively prevents incidence of undesired light beams to the lenses of the barrel 10.

In the assembling plate 13 according to the second modification of FIG. 6C, the baffle 13a formed at the center of the assembling plate 13 is a stepped hole, in the same manner as that described for the baffle 11a of FIG. 6A, but has downward extending skirts which extend downward along the edge of the plate 13.

Due to the stepped baffle 13a, the assembling plate 13 of FIG. 6C effectively intercepts diffused light beams, thus preventing incidence of the undesired light beams to the lenses of the barrel 10. In addition, the assembling plate 13 is more stably mounted to the upper surface of the barrel 10, due to the skirts.

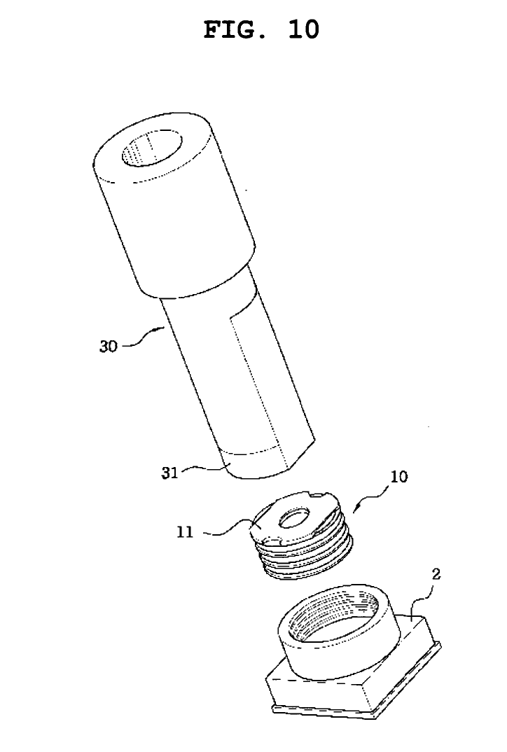

The assembling plate 11 of the present invention is provided with a plurality of tool holes 11b to allow an assembling tool, for example, an assembling handler 30 of FIG. 10, to engage with the plate 11 to transmit a rotating force of the tool to the barrel 10 when the barrel 10 having the plate 11 is assembled with the housing 2.

That is, when the barrel 10 having the assembling plate 11 is assembled with the housing 2, the assembling tool engages with the plate 11 such that the rotating force of the tool is effectively transmitted to the barrel 10 through the tool holes 11b. The barrel 10 is thus effectively rotated by the assembling tool so as to be assembled with the housing 2. In the assembling plate 11 of FIGS. 5 and 6A, two tool holes 11b are formed on the plate 11 at diametrically opposite positions. The two tool holes 11b, spaced apart from each other at angular interval of 180°, are open outward to have a notch shape.

However, the shape of the assembling plate of the present invention is not limited to the above-mentioned shapes, but the assembling plate may be designed to have a variety of shapes.

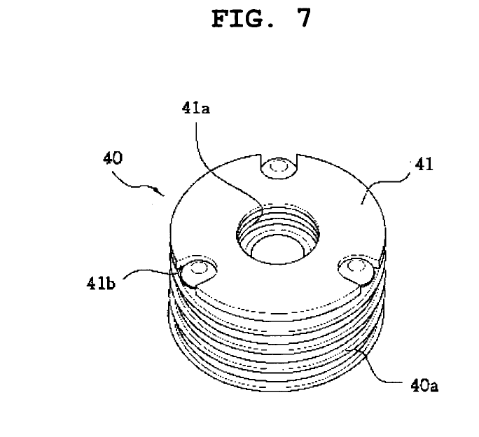

FIG. 7 is a perspective view of a barrel of a lens assembly, according to a second embodiment of the present invention. As shown in the drawing, the barrel 40 according to the second embodiment is a cylindrical body having external threads 40a on its external surface, with an assembling plate 41 mounted to an upper surface of the barrel 40

The assembling plate 41 mounted to the barrel 40 of the second embodiment is produced in the form of a circular disc having the same size as that of a cross-section of the cylindrical barrel 40.

The assembling plate 41 is preferably made of a magnetic material or a metal sheet which is magnetically attracted to a magnet.

In the same manner as that described for the first embodiment of the present invention, a baffle 41a is formed at the center of the assembling plate 41 so as to prevent an incidence of undesired light beams to the lenses of the barrel 40.

The assembling plate 41 of the second embodiment of the present invention is provided with three tool holes 41b to allow an assembling tool to engage with the plate 41 to transmit a rotating force of the tool to the barrel 40 when the barrel 40 having the plate 41 is assembled with a housing 2. The three tool holes 41b are formed on the plate 41 at three positions spaced apart from each other at regular angular intervals of 120°, and are open outward to have a notch shape.

Therefore, when the barrel 40 having the assembling plate 41 is assembled with a housing 2 using an assembling tool, the assembling tool engages with the plate 41 such that the rotating force of the tool is effectively transmitted to the barrel 10 through the tool holes 41b. The barrel 10 is thus effectively rotated by the assembling tool, and the process of assembling the barrel 40 with the housing 2 is thus easily performed.

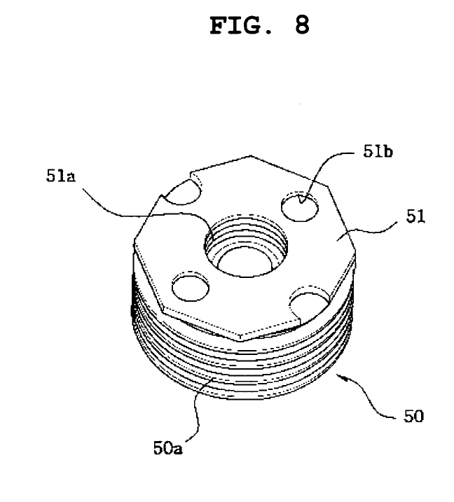

FIG. 8 is a perspective view of a barrel, according to a third embodiment of the present invention. As shown in the drawing, the barrel 50 according to the third embodiment is a cylindrical body having external threads 50a on its external surface, in the same manner as that described for the barrels 10 and 40 of the first and second embodiments of the present invention.

An assembling plate 51 is mounted to an upper surface of the barrel 50. The assembling plate 51 is preferably made of a magnetic material or a metal sheet which is magnetically attracted to a magnet.

The assembling plate 51 is produced in the form of a thin disc, with a baffle 51a formed at the center of the assembling plate 51 so as to prevent an incidence of undesired light beams to the lenses of the barrel 50.

The assembling plate 51 of the third embodiment has a polygonal disc shape, and is sized to cover most of the upper surface of the barrel 50, with a plurality of tool holes 51b formed at the plate 51.

The tool holes 51b comprise two notch-type tool holes formed on the plate 51 at diametrically opposite positions, and two circular tool holes formed on the plate 51 at positions spaced apart from the two notch-type tool holes at an angular interval of 90°. Therefore, when the barrel 50 having the assembling plate 51 is assembled with the housing 2, an assembling tool engages with the plate 51 such that the rotating force of the tool is effectively transmitted to the barrel 50 through the tool holes 51b. The process of assembling the barrel 50 with the housing 2 is thus easily performed.

As described above, the assembling plate mounted to the barrel of the present invention is preferably made of a magnetic material or a metal sheet that is magnetically attracted to a magnet, so that it is possible to improve work efficiency during the process of assembling the barrel with the housing. The apparatus and method of producing the digital camera module having the barrel according to the present invention will be described herein below.

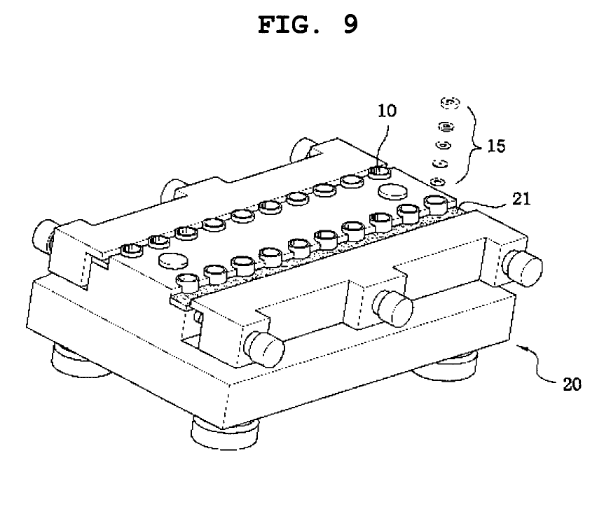

FIG. 9 is a jig 20 used in assembling one or more lenses in each barrel used as the lens holder to fabricate a plurality of lens assemblies of digital camera modules of the present invention.

In the jig 20 of the present invention, a plurality of barrel holding holes are arranged in two lines so as to hold a plurality of barrels 10 while setting one or more lenses in each of the barrels 10. The jig 20 performs the processes of assembling the lenses in the barrels 10 at the same time.

Each of the barrel holding holes of the jig 20 is designed such that a barrel 10 is seated in the barrel holding hole from a side of the jig 20. A longitudinal first magnet 21 is provided on the jig 20 such that the magnet 21 is placed at the bottom surfaces of the barrel holding holes, thus stably holding the barrels 10 in the barrel holding holes by magnetically attracting the assembling plates 11 of the barrels 10.

That is, two longitudinal magnets 21 are parallely arranged at both sides of the jig 20 to extend along the two lines of the barrel holding holes such that the magnets 21 magnetically hold the barrels 10 in the barrel holding holes.

Since the assembling plates 11 of the barrels 10 in the barrel holding holes of the jig 20 are magnetically supported by the magnets 21, it is easy to hold the barrels 10 in the jig 20. In addition, the barrels 10 are stably held in the jig 20 without being undesirably removed from the jig 20 or tilted in the jig 20, during the process of assembling the lenses in the barrels 10.

FIG. 10 is an exploded perspective view showing a method of assembling the barrel of FIG. 5 with a housing of the lens assembly of FIG. 4 by use of an assembling handler, according to the present invention. As shown in the drawing, the assembling handler 30 is provided at a first end thereof with a grip at which a worker grasps the handler 30 with his/her hand, and at a second end thereof with a second magnet 31.

Due to the magnet 31 of the assembling handler 30, the worker easily attaches the barrel 10 having the lenses to the handler 30.

That is, since the assembling plate 11 of the barrel 10 is magnetically attracted to the magnet 31 of the assembling handler 30, the worker who grasps the grip of the assembling handler 30 easily attaches the barrel 10 to the handler 30 by placing the magnet 31 of the handler 30 at a position around the plate 11 of the barrel 10 so as to allow the plate 11 to be magnetically attached to the magnet 31. Therefore, the worker easily and simply holds the barrel 10.

The magnet 31 has a profile corresponding to the plate 11, with a plurality of engaging projections (not shown) formed on the surface of the magnet 31 so as to be inserted into the tool holes 11b of the plate 11.

Since the engaging projections of the magnet 31 are inserted into the tool holes 11b of the plate 11, the rotating force of the assembling handler 30 is effectively transmitted to the barrel 10, so that the barrel 10 is reliably rotated and tightened to the internally threaded opening 2a of the housing 2. The work efficiency while assembling the barrel 10 with the housing 2 is thus improved.

In a brief description of the process of assembling the lens assembly, the worker grasping the grip of the assembling handler 30 places the magnet 31 of the handler 30 at a position around the plate 11 of the barrel 10, which is made of a magnetic material or a metal sheet, so that the plate 11 is magnetically attached to the magnet 31. Therefore, the barrel 10 is easily attached to the handler 30. In addition, the engaging projections of the magnet 31 are inserted into the tool holes 11b of the plate 11, so that the rotating force of the assembling handler 30 is effectively transmitted to the barrel 10, and the barrel 10 is reliably rotated and assembled with the housing 2.

The method of assembling the digital camera module of the present invention by use of the above-mentioned jig 20 and assembling handler 30 will be described in detail herein below.

At first, a plurality of barrels 10 are seated in the barrel holding holes of the jig 20 such that the plate 11 of each barrel 10 is placed on the magnet 21 provided at the bottom surface of each barrel holding hole.

Therefore, the plate 11 of each barrel 10 is magnetically attached to the magnet 21, so that the barrels 10 are easily and stably held in the barrel holding holes of the jig 20.

After the barrels 10 are stably held in the barrel holding holes of the jig 20, one or more lenses 15 are sequentially set in each barrel 10.

In such a case, the jig 20 magnetically and stably holds the barrels 10 in its barrel holding holes, so that it is possible to prevent the lenses from being misaligned or misassembled in each barrel 10.

That is, in a conventional process of producing digital camera modules, a worker must set one or more lenses sequentially in each barrel while holding the cap 1b of a capped barrel 1 or the external threads 5a of a capless barrel 5, prior to fixing the lenses in the barrel 1 or 5. Therefore, the lenses may be misaligned or misassembled in the barrel 1 or 5. However, the process of assembling the lenses in each barrel 10 of the present invention by use of the jig 20 accomplishes a desired alignment of the lenses in the barrel 10, and remarkably improves work efficiency during the lens assembly process, thus preventing lens assembly errors.

In addition, the lens assembly process of the present invention is performed, with the several barrels 10 seated in the barrel holding holes of the jig 20, so that it is possible to produce the lens assemblies in great quantities.

After the lenses are set in the barrel 10, the barrel 10 having the lenses is assembled with a housing 2. In the present invention, the process of assembling the barrel 10 with the housing 2 is accomplished by use of the assembling handler 30.

The assembling handler 30 is provided at the second end thereof with the magnet 31 to magnetically hold the barrel 10. Therefore, when the worker places the magnet 31 of the handler 30 at a position around the plate 11 of the barrel 10, the plate 11 is magnetically attracted to the magnet 31, so that the worker easily attaches the barrel 10 having the lenses to the handler 30.

In such a case, the engaging projections (not shown) that are formed on the surface of the magnet 31 of the handler 30 are inserted into the tool holes 11b of the plate 11. Therefore, the rotating force of the assembling handler 30 is effectively and reliably transmitted to the barrel 10, so that the barrel 10 is reliably rotated and tightened to the internally threaded opening 2a of the housing 2. It is thus easy to assemble the barrel 10 with the housing 2 into a lens assembly of the digital camera module.

During the process of assembling the barrel 10 having the lenses with the housing 2, it is necessary to precisely rotate the barrel 10 while carefully controlling the rotation angle of the barrel 10 relative to the housing 2 and repeatedly checking the lens focusing precision.

The digital camera module of the present invention is thus produced.

The method of assembling the digital camera module according to the present invention is performed by use of the assembling handler 30, it is very easy to set the precise lens focus of the digital camera, in comparison with a conventional assembling method.

Since the process of assembling barrels 10 to the housings 2 to produce the digital camera modules of the present invention is easily performed as described above, the digital camera module of the present invention can be produced in large quantities.

In the method of assembling the digital camera module according to the present invention, it is preferred to measure the lens alignment after the lenses 15 are set in the barrel 10.

In the method of assembling the digital camera module of the present invention, the process of assembling the lenses 15 in the barrel 10 having the assembling plate 11 made of a magnetic material is performed by use of the jig 20, so that it is easy to hold the barrel during the lens assembly process. In addition, during the lens assembly process, the lenses 15 are set in the barrel 10 which is stably held at a desired position, so that lens assembly errors can be prevented.

In addition, during the process of assembling the barrel 10 having the lenses 15 with the housing 2, the barrel 10 is held by the assembling handler 30 having the magnet 31, so that it is easy to assemble the barrel 10 with the housing 2.

As described above, the present invention provides a digital camera module, an apparatus and method of assembling the digital camera module. In the method of assembling the digital camera module of the present invention, one or more lenses are set in a barrel by use of a jig having a magnet, so that it is possible to stably hold the barrel at a desired position, while preventing the barrel from being tilted or moved during a lens assembly process. Therefore, lens assembly errors can be prevented.

Therefore, work efficiency and productivity during the process of assembling lenses with a barrel to produce a lens assembly of a miniaturized digital camera module are improved. In the present invention, the lenses are set in the barrel at desired precise positions.

Furthermore, during the process of assembling the lenses in the barrel to produce a lens assembly according to the present invention, a plurality of barrels are held in a jig at the same time and lenses are set in the barrels at the same time, so that the barrels having the lenses may be produced in large quantities. In addition, the barrels having the lenses are easily assembled with the housings into digital camera modules, so that the present invention allows mass production of the digital camera modules.

Another advantage of the present invention resides in that it is easy to accomplish the precise lens focus during the process of assembling the barrels with the housings, thus enhancing and making uniform performance of the digital camera modules, and improving work efficiency while producing the digital camera modules.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A digital camera module, comprising:
a barrel having external threads on an external surface thereof, with one or more lenses set in the barrel, and an assembling plate mounted to an upper surface of the barrel;
a camera module housing assembled with the barrel, the housing having an internally threaded opening through which the barrel is mounted to the housing;
an image sensor converting an image of a subject into an electrical image signal; and
a substrate having an electronic circuit, with the image sensor installed on the substrate.

2. The digital camera module according to claim 1, wherein the assembling plate is made of a magnetic material or a metal sheet which is magnetically attracted to a magnet.

3. The digital camera module according to claim 2, wherein the assembling plate is provided with a baffle so as to prevent an incidence of undesired light beams to the lenses of the barrel.

4. The digital camera module according to claim 2 or 3, wherein the assembling plate is provided with a plurality of tool holes so as to hold the barrel during a process of assembling the barrel with the housing.

5. The digital camera module according to claim 1, wherein the assembling plate is mounted to the upper surface of the barrel through a bonding technique by use of an adhesive.

6. A method of assembling a digital camera module, comprising:
holding a plurality of barrels, each having a magnetic assembling plate, in a jig having a first magnet;
assembling one or more lenses in each of the barrels held in the jig so as to align the lenses in the barrel;
attaching each of the barrels having the lenses to an assembling handler having a second magnet; and
assembling each of the barrels to a camera module housing by manipulating the assembling handler.

7. The method according to claim 6, further comprising:
measuring a lens alignment after the lenses are assembled in each of the barrels.

8. An apparatus for assembling a digital camera module, comprising:
a jig having a first magnet to hold a plurality of barrels each having a magnetic assembling plate at an end thereof; and
an assembling handler having a second magnet at an end thereof to be magnetically attached to the magnetic assembling plate of each of the barrels, the assembling handler being manipulated to assemble the barrel with a camera module housing.

9. The apparatus according to claim 8, wherein the jig has a plurality of barrel holding holes arranged in a line so as to hold the barrels such that a part of each of the barrels is seated in each of the barrel holding holes, with the first magnet placed at bottom surfaces of the barrel holding holes.

10. The apparatus according to claim 8, wherein the assembling plate of each of the barrels is provided with a tool hole, and the second magnet of the assembling handler has an engaging projection to be inserted into the tool hole of the assembling plate.
